(19) United States
(12) Patent Application Publication
(10) Pub. No.: US 2014/0177299 A1
(43) Pub. Date: Jun. 26, 2014

(54) INVERTER AND GRID-CONNECTED POWER GENERATION SYSTEM

(71) Applicants: Beijing BOE Energy Technology Co., Ltd., Beijing (CN); BOE Technology Group Co., Ltd., Beijing (CN)

(72) Inventors: Xuyang Wang, Beijing (CN); Hangbing Song, Beijing (CN); Xiaoyan Han, Beijing (CN); Ming Cui, Beijing (CN)

(73) Assignees: Beijing BOE Energy Technology Co., Ltd., Beijing (CN); BOE Technology Group Co., Ltd., Beijing (CN)

(21) Appl. No.: 14/107,236

(22) Filed: Dec. 16, 2013

(30) Foreign Application Priority Data
Dec. 21, 2012 (CN) 201220717473.X

(51) Int. Cl. H02M 7/537

(52) U.S. Cl. CPC H02M 7/537
USPC 363/65

(57) ABSTRACT

An inverter and a grid-connected power generation system are provided to efficiently reduce the electric energy loss due to a DC boosted circuit, improve the efficiency of a PV system, and increase lifetime of the inverter. The inverter comprises: a DC boosted circuit; an inversion circuit connected to a output end of the DC boosted circuit; and a bypass circuit, of which an input end is connected to a positive electrode input end of the DC boosted circuit, and an output end is connected to a positive electrode output end of the DC boosted circuit. When a DC input voltage applied to the DC boosted circuit is higher than a voltage required by the inversion circuit, the bypass circuit is turned on, and the DC input voltage is supplied to the inversion circuit through the bypass circuit; and when the DC input voltage is lower than the voltage required by the inversion circuit, the bypass circuit is turned off, and the DC input voltage is amplified by the DC boosted circuit and then supplied to the inversion circuit.

### CROSS-REFERENCE TO RELATED APPLICATION

This application claims the benefit of Chinese Patent Application No. 201220717473.X filed on Dec. 21, 2012 in the State Intellectual Property Office of China, the whole disclosure of which is incorporated herein by reference.

### BACKGROUND OF THE INVENTION

1. Field of the Invention

The invention relates to the technical field of photovoltaic (PV) grid-connected power generation, especially relates to a grid-connected inverter based on non-transformer type single-phase full-bridge inverter, and a grid-connected power generation system comprising same.

2. Description of the Related Art

PV grid-connected power generation technology is an important part of the renewable energy technology, and the grid-connected power generation system comprises mainly a solar panel, a PV grid-connected inverter and the like. The grid-connected power generation system is constructed to convert solar energy into electrical energy by the solar panel, output direct current (DC), and convert the DC into AC through the PV grid-connected inverter.

An inverter of an earlier PV grid-connected power generation system typically comprises an isolation transformer to realize voltage boosting and electrical isolation. However, a transformer having industrial frequency is bulky, costly, and large in energy loss, such that the entire efficiency of the system is highly affected. Therefore, in a case of application of small or medium-sized grid-connected inverters, especially for a grid-connected power generation system having single-phase full-bridge inverters, a non-transformer design is typically adopted to obtain an optimum efficiency and reduce the cost.

A grid-connected power generation system without isolation transformer usually comprises a DC boosted circuit, and a DC/AC inversion circuit for inverting direct voltage into alternating voltage. The DC boosted circuit is configured to track the maximum power and amplify the DC input voltage generated in the solar photovoltaic cell array. The DC boosted circuit is provided to raise the maximum power of the grid-connected power generation system, and flexibly configure the voltage of the solar photovoltaic cell array on a DC input side. Such that, the solar photovoltaic cell array can be operated in a broader range of application and users can choose different voltage configurations of the solar photovoltaic cell array of the solar panel. The inverter provided behind the DC boosted circuit usually adopts a typical full-bridge inverter as the grid-connected inverter of the grid-connected power generation system.

FIG. 1 shows the circuit principle diagram of the inverter having a bipolar type single-phase full-bridge inversion circuit. As shown in FIG. 1, the inverter comprises a DC boosted circuit 1, an inversion circuit 2, a capacitor C, a first inductor L1, and a second inductor L2.

In the DC boosted circuit 1, one end of a third inductor L3 is connected to the positive electrode input end Vᵢ₁⁺ of the DC boosted circuit 1, and the other end is connected to the positive electrode output end of the diode D2; the positive electrode of the diode D2 is connected to the third inductor L3, and the negative electrode of the diode D2 is connected to the positive electrode output end Vₒ₁⁺ of the DC boosted circuit 1; a collector electrode of a first switching transister Q1 is connected between the third inductor L3 and the diode D2, an emitter electrode thereof is connected to the negative electrode output end Vₒ₁⁻ of the DC boosted circuit 1, and an base electrode thereof is connected to a first control circuit. A DC input voltage U1 is inputted between the positive electrode input end Vᵢ₁⁺ and the negative electrode input end Vᵢ₁⁻.

In the inversion circuit 2, a collector electrode of a second switching transister Q2 is connected to the positive electrode input end Vᵢ₂⁺ of the inversion circuit 2, and an emitter electrode of the second switching transister Q2 is used as an output end Vₒ₂⁺ of the inversion circuit 2 and is connected to the first inductor L1; an collector electrode of a third switching transister Q3 is connected to the emitter of the second switching transister Q2, an emitter electrode of the third switching transister Q3 is connected to the negative electrode input end Vᵢ₂⁻ of the inversion circuit 2; a collector electrode of a fourth switching transister Q4 is connected to the positive electrode input end Vᵢ₂⁺ of the inversion circuit 2, an emitter electrode of the fourth switching transister Q4 is used as another output end Vₒ₂⁻ of the inversion circuit 2 and is connected to the second inductor L2; a collector electrode of the fifth switching transister Q5 is connected to the emitter of the fourth switching transister Q4, an emitter electrode of the fifth switching transister Q5 is connected to the negative electrode input end Vᵢ₂⁻ of the inversion circuit 2. Base electrodes of the second switching transister Q2 and the fifth switching transister Q5 are connected with a second control circuit, and base electrodes of the third switching transister Q3 and the fourth switching transister Q4 are connected with a third control circuit.

In the inversion circuit, the boosting function is achieved by the turn-on and turn-off the first switching transister Q1. More specifically, when the first switching transister Q1 is turned on, the current passes through the third inductor L3 and the first switching transister Q1, thus, the current in the third inductor L3 is increased, and the third inductor L3 accumulates energy. The inversion circuit 2 electrically connected behind the DC boosted circuit is supplied with current by the capacitor C. The diode D2 functions to block a circuit in which the capacitor C discharges through the first switching transister Q1. When the first switching transister Q1 is turned off, the diode D2 is turned on, and the capacitor C is charged under the coactions of the DC input voltage U1 and the reverse electromotive force of the third inductor L3, and the third inductor L3 releases energy.

During the turned-off the first switching transister Q1, the capacitor C is charged under the coactions of the DC input voltage U1 and the reverse electromotive force of the third inductor L3, such that the output voltage of the DC boosted circuit 1 is larger than the DC input voltage U1, so as to achieve the effect of boosting, and the value of the output voltage of the DC boosted circuit 1 depends on the inductance of the third inductor L3 and duration time during which the first switching transister Q1 is turned on.

In the prior art, the DC boosted circuit 1 still keep in operation even when the DC input voltage U1 is higher than the voltage required in the normal operation of the inversion circuit 2, such that unnecessary waste of electrical energy occurs, the efficiency of the inverter is lowered, and the lifetime of the inverter is shortened.

### SUMMARY OF THE INVENTION

The present invention has been made to overcome or alleviate at least one aspect of the above mentioned disadvantages.

Accordingly, it is an object of the present invention to provide an inverter and a grid-connected power generation system so as to efficiently reduce the electric energy loss due to the DC boosted circuit, improve the efficiency of the PV system, and increase lifetime of the inverter.

According to an aspect of the present invention, there is provided an inverter, which comprises: a DC boosted circuit; an inversion circuit connected to an output end of the DC boosted circuit; and a bypass circuit, of which an input end is connected to an positive electrode input end of the DC boosted circuit, and an output end is connected to a positive electrode output end of the DC boosted circuit, wherein when a DC input voltage applied to the DC boosted circuit is higher than a voltage required by the inversion circuit, the bypass circuit is turned on, and the DC input voltage is supplied to the inversion circuit through the bypass circuit; and when the DC input voltage is lower than the voltage required by the inversion circuit, the bypass circuit is turned off, and the DC input voltage is boosted by the DC boosted circuit and then supplied to the inversion circuit.

According to another aspect of the present invention, there is provided a grid-connected power generation system, which comprises the inverter in the above embodiment, wherein the DC input voltage is supplied by a solar PV system.

### BRIEF DESCRIPTION OF THE DRAWINGS

The above and other features of the present invention will become more apparent by describing in detail exemplary embodiments thereof with reference to the accompanying drawings, in which:

FIG. 1 is a drawing showing a circuit principle diagram of an inverter in the prior art;

FIG. 2 is a drawing showing a circuit principle diagram of an inverter according to an exemplary embodiment of the present invention.

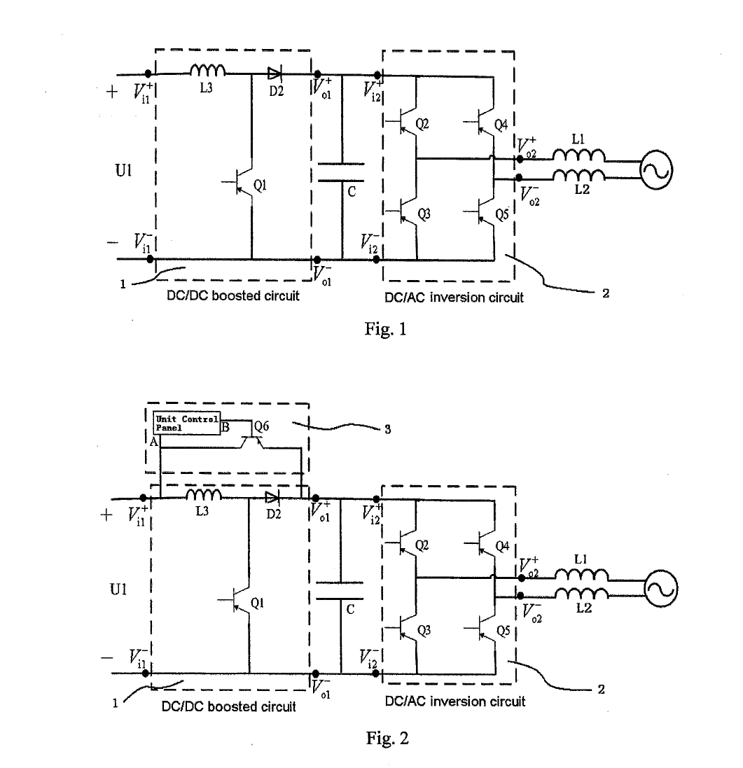

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

An inverter and a grid-connected power generation system are provided in embodiments of the present invention, so as to overcome the defects of high electrical energy loss, inefficient conversion and shortened lifetime in an inverter in the prior art.

FIG. 2 is a drawing showing a circuit principle diagram of an inverter having a bipolar type single-phase full-bridge inversion circuit according to an exemplary embodiment of the present invention. As shown in FIG. 2, the inverter according to the overall concept of the present invention comprises: a DC boosted circuit 1 configured to amplify a DC input voltage U1, an inversion circuit 2 connected to an output end of the DC boosted circuit 1 to convert DC voltage into AC voltage, and a bypass circuit 3. An input end of the bypass circuit 3 is connected to a positive electrode input end Vᵢ₁⁺ of the DC boosted circuit 1; an output end of the bypass circuit 3 is connected to a positive electrode output end Vₒ₁⁺ of the DC boosted circuit 1. When the DC input voltage U1 is higher than a voltage required by the inversion circuit 2, the bypass circuit 3 is turned on, so as to transmit the DC input voltage U1 directly to the inversion circuit 2. On the other hand, when the DC input voltage U1 is lower than the voltage required by the inversion circuit 2, the bypass circuit 3 is turned off, such that the DC input voltage U1 is amplified by the DC boosted circuit 1 and then inputted into the inversion circuit 2. In a further embodiment, the inverter also comprises a capacitor C connected between a positive electrode input end Vᵢ₂⁺ and a negative electrode input end Vᵢ₂⁻ the of the inversion circuit 2. In a still further embodiment, the inverter also comprises a first inductor and a second inductor connected respectively to a positive electrode output end Vₒ₂⁺ and a negative electrode output end Vₒ₂⁻ the of the inversion circuit 2.

Specifically, the positive electrode output end Vₒ₁⁺ of the DC boosted circuit 1 is connected with one end of the capacitor C, and a negative electrode output end Vₒ₁⁺ of the DC boosted circuit 1 is connected with the other end of the capacitor C; the positive electrode input end Vᵢ₂⁺ of the inversion circuit 2 is connected with the positive electrode output end Vₒ₁⁺ of the DC boosted circuit 1, and the negative electrode input end Vᵢ₂⁻ of the inversion circuit 2 is connected with the negative electrode output end Vₒ₁⁻ of the DC boosted circuit 1; one end of the first inductor L1 is connected with one of the positive output end Vₒ₂⁺ of the inversion circuit 2, and the other end of the first inductor L1 is connected to an external circuit. One end of the second inductor L2 is connected with the negative output end Vₒ₂⁻ of the inversion circuit 2, and the other end is connected to the external circuit. One end of the bypass circuit 3 is connected to the positive electrode input end Vᵢ₁⁺ of the DC boosted circuit 1, and the other end is connected to the positive electrode output end Vₒ₁⁺ of the DC boosted circuit 1.

According to the inverter in an exemplary embodiment of the invention, the DC boosted circuit 1 comprises a third inductor L3, a diode D2, and a first switching transistor Q1, wherein one end of the third inductor L3 is connected to the positive electrode input end Vᵢ₁⁺ of the DC boosted circuit 1, a positive electrode end of the diode D2 is connected to the third inductor L3, a negative electrode end of the diode D2 is connected to positive electrode output end Vₒ₁⁺ of the DC boosted circuit 1; a collector electrode of the first switching transister Q1 is connected between the third inductor L3 and the diode D2, an emitter electrode of the first switching transister Q1 is connected to the negative electrode input end Vₒ₁⁻ of the DC boosted circuit 1, and a base electrode is connected to a first control circuit.

In the DC boosted circuit 1, when the first switching transister Q1 is turned on, the current passes through the third inductor L3 and the first switching transister Q1, the current in the third inductor L3 is increased, and the third inductor L3 accumulates energy. The inversion circuit 2 connected to the output end of the DC boosted circuit is supplied with current by the capacitor C. At that time, the diode D2 blocks the circuit in which the capacitor C discharges through the first switching transister Q1. When the first switching transister Q1 is turned off, the diode D2 is turned on, and the capacitor C is charged under the coactions of the DC input voltage U1 and the reverse electromotive force of the third inductor L3, and the third inductor L3 releases energy.

According to the inverter in the exemplary embodiment of the present invention, the inversion circuit 2 comprises a voltage full-bridge inversion circuit. The inversion circuit comprises two half-bridge circuits. Therefore, the inversion circuit comprises four bridge arms which are divided into two pairs of bridge arms, and two non-adjacent arms forms a pair of bridge arm. The two arms in one pair are turned on simultaneously, and the two pairs of bridge arms are turned on/off alternatively.

The inversion circuit 2 comprises a second switching transister Q2, a third switching transister Q3, a fourth switching transister Q4, and a fifth switching transister Q5. On/off states of the four bridge arms are controlled by the second Q2, the third Q3, the fourth Q4, and the fifth switching transister Q5, respectively. Specifically, a collector electrode of the second switching transister Q2 is connected to the positive electrode input end Vᵢ₂⁺ of the inversion circuit 2, an emitter electrode of the second switching transister Q2 is the positive electrode output end Vₒ₂⁺ of the inversion circuit 2 and the first inductor L1. A collector electrode of the third switching transister Q3 is connected to the emitter electrode of the second switching transister Q2, and an emitter electrode of the third switching transister Q3 is connected to the negative electrode input end Vᵢ₂⁻ of the inversion circuit 2. A collector electrode of the fourth switching transister Q4 is connected to the positive electrode input end Vᵢ₂⁺ of the inversion circuit 2, an emitter electrode of the fourth switching transister Q4 is the negative electrode output end Vₒ₂⁻ of the inversion circuit 2 and the second inductor L2. A collector electrode of the fifth switching transister Q5 is connected to the emitter electrode of the fourth switching transister Q4, and an emitter electrode of the fifth switching transister Q5 is connected to the negative electrode input end Vᵢ₂⁻ of the inversion circuit 2. Base electrodes of the second switching transister Q2 and the fifth switching transister Q5 are connected to a second control circuit, so that the second control circuit controls the on/off state of the second switching transister Q2 and the fifth switching transister Q5; base electrodes of the third switching transister Q3 and the fourth switching transister Q4 are connected to a third control circuit, so that the third control circuit control the on/off state of the third switching transister Q3 and the fourth switching transister Q4.

When the second switching transister Q2 and the fifth switching transister Q5 are turned on under the control of the second control circuit, the current passes through a circuit comprising the second switching transister Q2, the first inductor L1, the external circuit, the second inductor L2, and the fifth switching transister Q5. The third switching transister Q3 and the fourth switching transister Q4 are turned on under the control of the third control circuit, the current passes through a circuit comprising the fourth switching transister Q4, the second inductor L2, the external circuit, the first inductor L1, and the third switching transister Q3.

According to the inverter in the exemplary embodiment of the present invention, the bypass circuit 3 comprises a switching circuit and a bypass control circuit, wherein both ends of the switching circuit are connected to the positive electrode input end Vᵢ₁⁺ and the positive electrode output end Vₒ₁⁺, which is connected with the negative end of the diode, of the DC boosted circuit 1. The bypass control circuit is configured such that the switching circuit is turned on when the DC input voltage U1 is higher than the voltage required by the inversion circuit 2, and the switching circuit is turned off when the DC input voltage U1 is lower than the voltage required by the inversion circuit 2.

In a further exemplary embodiment, the switching circuit comprises a sixth switching transistor Q6, and the bypass control circuit comprises a unit control panel. An end A and an end B of the unit control panel are connected to a collector electrode and a base electrode of the sixth switching transistor Q6, respectively, and can sample a corresponding voltage signal or current signal of the DC input voltage U1 through a voltage sampler or current sampler. The collector electrode and the emitter electrode of the switching transistor Q6 are connected to the positive electrode input end Vᵢ₁⁺ and the positive electrode output end Vₒ₁⁺, respectively. When the DC input voltage is higher than the voltage required by the inversion circuit 2, the unit control panel supplies a high-level signal to the base electrode of the sixth switching transistor Q6, and the sixth switching transistor Q6 is turned on. When the DC input voltage is lower than the voltage required by the inversion circuit 2, the unit control panel supplies a low-level signal to the base electrode of the sixth switching transistor Q6, and the sixth switching transistor Q6 is turned off.

Because the base electrode of the sixth switching transistor Q6 is connected to the bypass control circuit, the bypass control circuit is used to control the on/off state of the sixth switching transistor Q6. When the DC input voltage U1 is higher than the voltage required by the inversion circuit 2, the unit control panel supplies a high-level signal to the base electrode of the sixth switching transistor Q6, and the sixth switching transistor Q6 is turned on. When the DC input voltage U1 is lower than the voltage required by the inversion circuit 2, the unit control panel supplies a low-level signal to the base electrode of the sixth switching transistor Q6, and the sixth switching transistor Q6 is turned off, wherein the voltage required by the inversion circuit 2 is the minimum voltage under which the inversion circuit 2 could operate normally. In the inverter disclosed in the exemplary embodiment of the present invention, the voltage required by the inversion circuit 2 is set to about 700V. It is appreciated that, normally, the voltage required by the inversion circuit 2 can be varied if necessary.

When the sixth switching transistor Q6 is turned off, the DC boosted circuit 1 functions to amplify the DC input voltage U1. The inverter of the present invention comprises a two-step energy conversion comprising a DC-to-DC conversion and a DC-to-AC inversion. When the sixth switching transistor Q6 is turned on, the DC boosted circuit 1 does not have the function of boosting the DC input voltage U1, and the DC input voltage is directly inverted to AC voltage through the inversion circuit 2, so in this case, the inverter comprises only a single-step energy conversion comprising a DC-to-AC inversion.

In another examplary embodiment of the present invention, there is provided a grid-connected power generation system comprising the inverter in any one of the above embodiments.

From the above, the embodiments of the invention disclose an inverter and a grid-connected power generation system, wherein the inverter comprises a bypass circuit. When the DC input voltage, for example, generated by a solar PV system, is lower than the voltage required by the inversion circuit, the bypass circuit does not operate and the DC boosted circuit boosts normally the DC input voltage. When the DC input voltage generated by the solar PV system is higher than the voltage required by the inversion circuit, the bypass circuit functions to short the DC boosted circuit, and the DC boosted circuit does not operate. The inverter disclosed in the invention could effectively reduce the power consumed by the DC boosted circuit, and improve the efficiency of the solar PV system.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An inverter, which comprises:
a DC boosted circuit;
an inversion circuit connected to an output end of the DC boosted circuit; and
a bypass circuit, of which an input end is connected to a positive electrode input end of the DC boosted circuit, and an output end is connected to a positive electrode output end of the DC boosted circuit, wherein
when a DC input voltage applied to the DC boosted circuit is higher than a voltage required by the inversion circuit, the bypass circuit is turned on, and the DC input voltage is supplied to the inversion circuit through the bypass circuit; and when the DC input voltage is lower than the voltage required by the inversion circuit, the bypass circuit is turned off, and the DC input voltage is amplified by the DC boosted circuit and then supplied to the inversion circuit.

2. The inverter according to claim 1, further comprising:
a capacitor connected between a positive electrode input end and a negative electrode input end of the inversion circuit.

3. The inverter according to claim 1, further comprising:
a first inductor, of which one end is connected to a positive electrode output end of the inversion circuit, the other end is connected to an external circuit, and
a second inductor, of which one end is connected to a negative electrode output end of the inversion circuit, the other end is connected to the external circuit.

4. The inverter according to claim 1, wherein the DC boosted circuit comprises:
a third inductor, of which one end is connected to the positive electrode input end of the DC boosted circuit;
a diode, of which a positive electrode end is connected to the other end of the third inductor, a negative electrode end is connected to the positive electrode input end of the inversion circuit; and
a first switch transistor, of which a collector electrode is connected between the third inductor and the diode, an emitter electrode is connected to the negative electrode input end of the DC boosted circuit.

5. The inverter according to claim 1, wherein the inversion circuit comprises a voltage full-bridge inversion circuit.

6. The inverter according to claim 5, wherein the inversion circuit comprises:
a second switch transistor, of which a collector electrode is connected to the positive electrode input end of the inversion circuit, and an emitter electrode is connected to the positive electrode output end of the inversion circuit;
a third switch transistor, of which a collector electrode is connected to the emitter electrode of the second switch transistor, and an emitter electrode is connected to the negative electrode input end of the inversion circuit;
a fourth switch transistor, of which a collector electrode is connected to the positive electrode input end of the inversion circuit, and an emitter electrode is connected to the negative electrode output end of the inversion circuit; and
a fifth switch transistor, of which a collector electrode is connected to the emitter electrode of the fourth switch transistor, and an emitter electrode is connected to the negative electrode input end of the inversion circuit.

7. The inverter according to claim 1, wherein the bypass circuit comprises:
a switching circuit with both ends connected to the positive electrode input end and positive electrode output end of the DC boosted circuit, respectively, and
a bypass control circuit configured such that the switching circuit is turned on when the DC input voltage is higher than the voltage required by the inversion circuit, and the switching circuit is turned off when the DC input voltage is lower than the voltage required by the inversion circuit.

8. The inverter according to claim 7, wherein the switching circuit comprises a sixth switching transistor; and the bypass control circuit comprises a unit control panel;
the unit control panel is connected between a collector electrode and a base electrode of the sixth switching transistor; the collector electrode and a emitter electrode of the sixth switching transistor are connected to the positive electrode input end and the positive electrode output end of the DC boosted circuit, respectively; and
the unit control panel is configured such that the sixth switching transistor is turned on when the DC input voltage is higher than the voltage required by the inversion circuit, and the sixth switching transistor is turned off when the DC input voltage is lower than the voltage required by the inversion circuit.

9. The inverter according to claim 7, wherein the voltage required by the inversion circuit is set as about 700V.

10. A grid-connected power generation system, comprising the inverter of claim 1, wherein the DC input voltage is supplied by a solar PV system.

11. The grid-connected power generation system of claim 10, further comprising:
a capacitor connected between a positive electrode input end and a negative electrode input end of the inversion circuit.

12. The grid-connected power generation system according to claim 11, further comprising:
a first inductor, of which one end is connected to a positive electrode output end of the inversion circuit, the other end is connected to an external circuit, and
a second inductor, of which one end is connected to a negative electrode output end of the inversion circuit, the other end is connected to the external circuit.

13. The grid-connected power generation system according to claim 10, wherein the DC boosted circuit comprises:
a third inductor, of which one end is connected to the positive electrode input end of the DC boosted circuit;
a diode, of which the positive electrode end is connected to the other end of the third inductor, the negative electrode end is connected to the positive electrode input end of the inversion circuit; and
a first switch transistor, of which a collector electrode is connected between the third inductor and the diode, an emitter electrode is connected to the negative electrode input end of the DC boosted circuit.

14. The grid-connected power generation system according to claim 10, wherein the inversion circuit comprises a voltage full-bridge inversion circuit.

15. The grid-connected power generation system according to claim 14, wherein the inversion circuit comprises:
a second switch transistor, of which a collector electrode is connected to the positive electrode input end of the inversion circuit, and an emitter electrode is connected to the positive electrode output end of the inversion circuit;
a third switch transistor, of which a collector electrode is connected to the emitter electrode of the second switch transistor, and an emitter electrode is connected to the negative electrode input end of the inversion circuit;
a fourth switch transistor, of which a collector electrode is connected to the positive electrode input end of the inversion circuit, and an emitter electrode is connected to the negative electrode output end of the inversion circuit; and
a fifth switch transistor, of which a collector electrode is connected to the emitter electrode of the fourth switch transistor, and an emitter electrode is connected to the negative electrode input end of the inversion circuit.

16. The grid-connected power generation system according to claim 10, wherein the bypass circuit comprises:
a switching circuit with both ends connected to the positive electrode input end and positive electrode output end of the DC boosted circuit respectively, and
a bypass control circuit configured such that the switching circuit is turned on when the DC input voltage is higher than the voltage required by the inversion circuit, and the switching circuit is turned off when the DC input voltage is lower than the voltage required by the inversion circuit

17. The grid-connected power generation system according to claim 16, wherein the switching circuit comprises a sixth switching transistor; and the bypass control circuit comprises a unit control panel;
the unit control panel is connected between a collector electrode and a base electrode of the sixth switching transistor; the collector electrode and a emitter electrode of the sixth switching transistor are connected to the positive electrode input end and the positive electrode output end of the DC boosted circuit, respectively; and
the unit control panel is configured such that the sixth switching transistor is turned on when the DC input voltage is higher than the voltage required by the inversion circuit, and the sixth switching transistor is turned off when the DC input voltage is lower than the voltage required by the inversion circuit.

18. The grid-connected power generation system according to claim 16, wherein the voltage required by the inversion circuit is set as about 700V.
